(19) United States
(12) Patent Application Publication
(10) Pub. No.: US 2025/0368864 A1
(43) Pub. Date: Dec. 4, 2025

(54) ELECTROCONDUCTIVE PRESSURE-SENSITIVE ADHESIVE TAPE

(71) Applicant: DIC Corporation, Tokyo (JP)

(72) Inventors: Junpei Hamada, Ibaraki (JP); Katsuaki Imai, Saitama (JP)

(73) Assignee: DIC Corporation, Tokyo (JP)

(21) Appl. No.: 19/304,903

(22) Filed: Aug. 20, 2025

Related U.S. Application Data
(63) Continuation of application No. PCT/JP2024/006418, filed on Feb. 22, 2024.

(30) Foreign Application Priority Data
Mar. 7, 2023 (JP) 2023-034467

(51) Int. Cl. C09J 7/38; C09J 9/02; C09J 123/22

(52) U.S. Cl. CPC C09J 7/383; C09J 9/02; C09J 123/22; C09J 2203/33; C09J 2301/302

(57) ABSTRACT

An electroconductive pressure-sensitive adhesive tape includes at least an electroconductive pressure-sensitive adhesive layer containing at least a rubber component and electroconductive particles. The rubber component contains a polyisobutylene (A) having a viscosity average molecular weight of 400,000 or more and 800,000 or less and a polyisobutylene (B) having a viscosity average molecular weight of 100,000 or less. The electroconductive pressure-sensitive adhesive tape achieves both a superior adhesive property and a high swelling resistance to an electrolyte layer, especially, a high swelling resistance to an electrolyte layer containing dimethyl carbonate.

### TECHNICAL FIELD

One or more embodiments of the present invention relate to an electroconductive pressure-sensitive adhesive tape.

### BACKGROUND

Recently, with the rapid popularization and performance improvement of electronic devices, such as personal computers and mobile devices, electric cars, hybrid cars, and the like, further development of cells, batteries, and the like (hereinafter referred to as a cell or the like) has been advanced.

For example, a lithium-ion secondary battery has a structure that includes a positive electrode including a positive electrode active material layer and a positive electrode collector, a negative electrode including a negative electrode active material layer and a negative electrode collector, and an electrolyte layer disposed between the positive electrode active material layer and the negative electrode active material layer. Examples of the electrolyte layer used in a lithium-ion secondary battery include a layer of an electrolytic solution in which an electrolyte is dissolved in an aprotic solvent (nonaqueous solvent), such as propylene carbonate or ethylene carbonate, and an electrolyte layer formed of a polymer gel impregnated with the electrolytic solution. Furthermore, in recent years, all solid batteries in which a solid electrolyte layer is used has been actively developed and studied.

In an inner structure of a cell or the like, a pressure-sensitive adhesive tape is sometimes used for bonding members. For example, PTL 1 discloses a power storage device in which an electroconductive pressure-sensitive adhesive layer is disposed between a positive electrode and a positive electrode collector and/or between a negative electrode and a negative electrode collector.

### PATENT LITERATURE

PTL 1: JP 2013-118058 A

### SUMMARY

A tape with an electroconductive pressure-sensitive adhesive layer (electroconductive pressure-sensitive adhesive tape) is expected to ensure electrical conductivity of bonding parts by bonding members that constitute the interior of a cell or the like or by intervening between the members, to thus reduce internal resistance of the cell, thereby improving the cycle characteristics of the cell. However, when the electroconductive pressure-sensitive adhesive tape comes in contact with an electrolyte layer or is immersed in an electrolyte layer that is a liquid layer (electrolytic solution) in the interior of a cell or the like, the electroconductive pressure-sensitive adhesive tape swells and becomes easily detached from adherends, such as electrodes and electrolyte layers. Thus, the conduction between the members in contact via the electroconductive pressure-sensitive adhesive tape is not ensured, and degrades the cycle characteristics of the cell. In particular, electroconductive pressure-sensitive adhesive tapes are liable to considerably swell through contact with an electrolyte layer containing dimethyl carbonate or immersion in the electrolyte layer that is a liquid layer (electrolytic solution), which is more liable to cause the above.

On the other hand, in an electroconductive pressure-sensitive adhesive tape, an increase in the swelling resistance tends to lead to a poor adhesive force so that the tape cannot firmly adhere to members that constitute a cell or the like but is easily detached from the members. Thus, the conduction between the members in contact via the electroconductive pressure-sensitive adhesive tape is not ensured, easily causing degradation of the cycle characteristics of the cell.

One or more embodiments of the present invention have been made in view of the above circumstance, and provides an electroconductive pressure-sensitive adhesive tape capable of achieving both a superior adhesive property and a high swelling resistance to an electrolyte layer, especially, a high swelling resistance to an electrolyte layer containing dimethyl carbonate.

One or more embodiments of the present invention include the following embodiments.
[1] An electroconductive pressure-sensitive adhesive tape including at least an electroconductive pressure-sensitive adhesive layer,
   the electroconductive pressure-sensitive adhesive layer containing at least a rubber component and electroconductive particles,
   the rubber component containing a polyisobutylene (A) that has a viscosity average molecular weight of 400,000 or more and 800,000 or less and a polyisobutylene (B) that has a viscosity average molecular weight of 100,000 or less.
[2] The electroconductive pressure-sensitive adhesive tape according to the above [1], in which the polyisobutylene (A) and the polyisobutylene (B) are contained in a weight ratio [(A)/(B)] in the range of 1/9 to 9/1.
[3] The electroconductive pressure-sensitive adhesive tape according to the above [1] or [2], in which the electroconductive pressure-sensitive adhesive layer further contains a tackifying resin.
[4] The electroconductive pressure-sensitive adhesive tape according to the above [3], in which the tackifying resin is one or two or more selected from an aliphatic hydrocarbon resin, an alicyclic hydrocarbon resin, an aliphatic-alicyclic hydrocarbon resin, and a hydrogenated resin thereof.
[5] The electroconductive pressure-sensitive adhesive tape according to the above [3] or [4], in which the tackifying resin is contained in an amount of 80 parts by weight or less relative to 100 parts by weight of the rubber component.
[6] The electroconductive pressure-sensitive adhesive tape according to any of the [1] to [5], in which both surfaces of the electroconductive pressure-sensitive adhesive layer each form a pressure-sensitive adhesive surface of the electroconductive pressure-sensitive adhesive tape.
[7] The electroconductive pressure-sensitive adhesive tape according to any of the above [1] to [6], which shows a weight change rate (swelling rate) of the electroconductive pressure-sensitive adhesive layer of 10% by weight or less from before to after leaving the electroconductive pressure-sensitive adhesive tape immersed in dimethyl carbonate in an environment of 23° C. and 50% RH for 1 week.
[8] The electroconductive pressure-sensitive adhesive tape according to any of the above [1] to [7], in which the electroconductive pressure-sensitive adhesive tape has a 180-degree peeling adhesive force of 5 N/20 mm or more as measured according to JISZ2037.
[9] The electroconductive pressure-sensitive adhesive tape according to any of the above [1] to [8], which is to be used in a cell or a battery.
[10] The electroconductive pressure-sensitive adhesive tape according to any of the above [1] to [9], which is to be used in contact with an electrolyte layer.
[11] A cell or a battery in which the electroconductive pressure-sensitive adhesive tape according to any of the above [1] to is used.

According to the electroconductive pressure-sensitive adhesive tape of one or more embodiments of the present invention, it is possible to exhibit a superior adhesive property and a high swelling resistance to an electrolyte layer.

### DETAILED DESCRIPTION

One or more embodiments of the present invention will be described in detail below, but one or more embodiments of the present invention are not to be limited to the embodiments.

The electroconductive pressure-sensitive adhesive tape of one or more embodiments of the present invention includes at least an electroconductive pressure-sensitive adhesive layer, the electroconductive pressure-sensitive adhesive layer containing at least a rubber component and electroconductive particles, the rubber component containing a polyisobutylene (A) that has a viscosity average molecular weight of 400,000 or more and 800,000 or less and a polyisobutylene (B) that has a viscosity average molecular weight of 100,000 or less.

When an electroconductive pressure-sensitive adhesive tape is used in a cell or a battery, an electroconductive pressure-sensitive adhesive tape easily swells by coming into contact with or being immersed in an electrolyte layer, and the swelling electroconductive pressure-sensitive adhesive layer is loosened or detached from a surface of an adherend. On the other hand, when the swelling resistance of an electroconductive pressure-sensitive adhesive tape is enhanced, the adhesive force is decreased, and the tape cannot firmly adhere to members constituting the cell or battery and is easily detached from the members. When the tape is loosened or detached from a surface of an adherend due to swelling of the tape caused by contact with or immersion in an electrolyte layer or a poor adhesive property of the tape as described above, the electroconductive pressure-sensitive adhesive tape cannot sufficiently exhibit an electroconductive function to the adherend and conduction failure occurs between members in contact via the electroconductive pressure-sensitive adhesive tape, resulting in impairing the cycle characteristics of the cell. Thus, an electroconductive pressure-sensitive adhesive tape is required to achieve both the adhesive property (fixing ability) and the swelling resistance to an electrolyte layer.

Regarding the above request, according to one or more embodiments of the present invention, by incorporating into an electroconductive pressure-sensitive adhesive layer, in addition to electroconductive particles, a polyisobutylene (A) having a viscosity average molecular weight of 400,000 or more and 800,000 or less and a polyisobutylene (B) having a viscosity average molecular weight of 100,000 or less, the balance between the adhesive property and the cohesive property of the electroconductive pressure-sensitive adhesive layer can be achieved. With this configuration, the electroconductive pressure-sensitive adhesive tape of one or more embodiments of the present invention can achieve both a high adhesive property and such a swelling resistance that the tape is less liable to swell when brought into contact with or immersed in an electrolyte layer, thereby being capable of sufficiently adhering to an adherend in a cell and exhibiting an electroconductive function to the adherend. In addition, when the electroconductive pressure-sensitive adhesive tape of one or more embodiments of the present invention is used in the interior of a cell or the like, especially between an electrolyte layer and another member constituting the cell, it is possible to enhance the electrical conductivity between the electrolyte layer and the other member by the use of the electroconductivity of the electroconductive pressure-sensitive adhesive tape, thus improving the cycle characteristics of the cell.

In particular, the electroconductive pressure-sensitive adhesive tape of one or more embodiments of the present invention is also superior in the swelling resistance to an electrolyte layer containing dimethyl carbonate. Since dimethyl carbonate more easily enter an electroconductive pressure-sensitive adhesive layer than propylene carbonate which is generally used in an electrolyte layer, an electroconductive pressure-sensitive adhesive layer tends to swell more. The electroconductive pressure-sensitive adhesive tape of one or more embodiments of the present invention can achieve both a high swelling resistance and an adhesive property even when being used in a cell in which an electrolyte layer containing dimethyl carbonate is used.

In one or more embodiments of the present invention, the swelling resistance to an electrolyte layer refers to a property in which, when the electroconductive pressure-sensitive adhesive tape is in contact with an electrolyte layer or is immersed in an electrolyte layer that is a liquid layer, the liquid contained in the electrolyte layer (electrolytic solution or nonaqueous solvent) is less liable to enter (less liable to penetrate) the electroconductive pressure-sensitive adhesive layer. When an electroconductive pressure-sensitive adhesive tape has a high swelling resistance, a liquid contained in an electrolyte layer is less liable to enter the electroconductive pressure-sensitive adhesive tape, and thus, the change in the weight of the electroconductive pressure-sensitive adhesive tape from before to after the contact with or immersion in the electrolyte layer can be reduced. On the other hand, when the electroconductive pressure-sensitive adhesive tape has a low swelling resistance, a liquid contained in an electrolyte layer easily enters the electroconductive pressure-sensitive adhesive tape, and thus, the change in weight of the electroconductive pressure-sensitive adhesive tape from before to after the contact with or immersion in the electrolyte layer is increased. Note that the electrolyte layer may be a liquid layer constituted of an electrolytic solution or may be a semi-solid layer containing an electrolytic solution (for example, gel polymer electrolyte layer), or may be a solid layer (solid electrolyte layer) containing an electrolytic solution or a nonaqueous solvent. Alternatively, the electrolyte layer may be a solid electrolyte layer not containing an electrolytic solution or a nonaqueous solvent.

The electroconductive pressure-sensitive adhesive tape of one or more embodiments of the present invention may be any that includes at least an electroconductive pressure-sensitive adhesive layer, and may be a substrate-less electroconductive pressure-sensitive adhesive tape in which the both surfaces of the electroconductive pressure-sensitive adhesive layer each form an pressure-sensitive adhesive surface of the electroconductive pressure-sensitive adhesive tape or may be an electroconductive pressure-sensitive adhesive tape in which an electroconductive pressure-sensitive adhesive layer is provided directly or via another layer on one surface or both surfaces of an electroconductive substrate. An electroconductive pressure-sensitive adhesive tape of a double-sided pressure-sensitive adhesion specification is preferred since it can firmly bond members constituting a cell or the like. In addition, a substrate-less electroconductive pressure-sensitive adhesive tape is preferred from the viewpoint of thinning. Note that “substrate-less” refers to a specification in which a tape structure except for a release liner is composed only of a pressure-sensitive adhesive layer.

The electroconductive pressure-sensitive adhesive tape of one or more embodiments of the present invention may have a release liner on one surface or both surfaces of the electroconductive pressure-sensitive adhesive layer. The electroconductive substrate and the release liner will be described in detail in the section of “2. Optional Constitutional Member” described later.

### 1. Electroconductive Pressure-Sensitive Adhesive Layer

The electroconductive pressure-sensitive adhesive layer in one or more embodiments of the present invention contains at least a rubber component and electroconductive particles, the rubber component containing a polyisobutylene (A) that has a viscosity average molecular weight of 400,000 or more and 800,000 or less and a polyisobutylene (B) that has a viscosity average molecular weight of 100,000 or less.

In other words, the electroconductive pressure-sensitive adhesive layer is constituted of an electroconductive pressure-sensitive adhesive that contains at least: a rubber-based pressure-sensitive adhesive that contains, as a main component, a rubber component containing a polyisobutylene (A) that has a viscosity average molecular weight of 400,000 or more and 800,000 or less and a polyisobutylene (B) that has a viscosity average molecular weight of 100,000 or less; and electroconductive particles.

### (1) Rubber-Based Pressure-Sensitive Adhesive

The rubber-based pressure-sensitive adhesive that constitutes the electroconductive pressure-sensitive adhesive layer may be any that contains as a main component a rubber component containing the polyisobutylene (A) and the polyisobutylene (B), and can contain, besides the rubber component, an optional component, such as a crosslinking agent or a tackifying resin as described later.

The main component of the rubber-based pressure-sensitive adhesive refers to a component that is contained in the largest amount among the components that constitute the rubber-based pressure-sensitive adhesive. In particular, the content of the rubber component in the entire amount of the rubber-based pressure-sensitive adhesive may be 50% by weight or more, 70% by weight or more, 90% by weight or more, or 95% by weight or more.

In addition, the amount of the rubber component contained in the entire amount (100% by weight) of the electroconductive pressure-sensitive adhesive layer may be 35% by weight or more, 50% by weight or more, 60% by weight or more, 70% by weight or more, or 90% by weight or more.

### Rubber Component

The rubber component contains at least the polyisobutylene (A) and the polyisobutylene (B). The polyisobutylene (A) contained in the rubber component may be one kind or may be two or more kinds having the same or different viscosity average molecular weights. Similarly, the polyisobutylene (B) contained in the rubber component may be one kind or may be two or more kinds having the same or different viscosity average molecular weights.

The polyisobutylene (A) and the polyisobutylene (B) are each an isobutylene homopolymer.

The polyisobutylene (A) has a viscosity average molecular weight of 400,000 or more and 800,000 or less. When the cohesive force of the electroconductive pressure-sensitive adhesive layer is decreased to make the layer softer and coarser for enhancing the adhesive force to an adherend, such as an electrode or an electrolyte layer, a liquid contained in the electrolyte layer is more liable to enter the electroconductive pressure-sensitive adhesive layer and the layer is easily swell. In contrast, according to one or more embodiments of the present invention, by the electroconductive pressure-sensitive adhesive layer containing the polyisobutylene (A), it is possible to enhance the cohesive force of the electroconductive pressure-sensitive adhesive layer to make the layer appropriately hard and dense while exhibiting a high adhesive force to the adherend, and thus, a liquid contained in an electrolyte layer is less liable to enter the electroconductive pressure-sensitive adhesive layer, whereby swelling of the electroconductive pressure-sensitive adhesive layer can be prevented.

From the viewpoint of enhancing the cohesive force of the electroconductive pressure-sensitive adhesive layer, the viscosity average molecular weight (Mv) of the polyisobutylene (A) may be any that is 400,000 or more, and from the viewpoint that the electroconductive pressure-sensitive adhesive layer exhibits a high adhesive property, the viscosity average molecular weight (Mv) may be any that is 800,000 or less. In particular, since the cohesive force of the electroconductive pressure-sensitive adhesive layer can be more enhanced, the viscosity average molecular weight (Mv) may be 500,000 or more, 600,000 or more, or 700,000 or more. In addition, the viscosity average molecular weight (Mv) of the polyisobutylene (A) may be any that is 800,000 or less, can be less than 800,000, and in particular, since the adhesive property of the electroconductive pressure-sensitive adhesive layer can be more enhanced, the viscosity average molecular weight (Mv) may be 700,000 or less, 600,000 or less, or 500,000 or less. When the viscosity average molecular weight (Mv) of the polyisobutylene (A) is too large, a sufficient adhesive property is hardly achieved even when the polyisobutylene (B) is used together, and it is difficult to achieve both the swelling resistance and the adhesive property.

The viscosity average molecular weight (Mv) of the polyisobutylene (A) may be 400,000 or more and 800,000 or less, 400,000 or more and less than 800,000, 400,000 or more and 700,000 or less, 400,000 or more and 600,000 or less, or 500,000 or more and 600,000 or less. When the viscosity average molecular weight (Mv) of the polyisobutylene (A) is in the above range, it is possible to achieve both the cohesive property and the adhesive property of the electroconductive pressure-sensitive adhesive layer in a well-balanced manner.

The polyisobutylene (A) may be generally solid at a normal temperature (23° C.). Examples of a commercially available polyisobutylene that can be used as the polyisobutylene (A) include, but not limited to, “OPPANOL N” series (OPPANOL 50, OPPANOL 80, etc.) manufactured by BASF.

The polyisobutylene (B) has a viscosity average molecular weight (Mv) of 100,000 or less. When the cohesive force of an electroconductive pressure-sensitive adhesive layer is enhanced to make the layer harder and denser for preventing swelling due to contact with or immersion in an electrolyte layer, the layer cannot firmly adhere to an adherend, such as an electrode or an electrolyte layer, and the adhesive force is reduced. In contrast, according to one or more embodiments of the present invention, by the electroconductive pressure-sensitive adhesive layer containing the polyisobutylene (B), an appropriate softness can be exhibited to increase the adhesive force to the adherent while maintaining a high cohesive force of the electroconductive pressure-sensitive adhesive layer. In particular, the viscosity average molecular weight (Mv) of the polyisobutylene (B) may be 10,000 or more and 100,000 or less, 20,000 or more and 80,000 or less, or 30,000 or more and 60,000 or less. When the viscosity average molecular weight (Mv) of the polyisobutylene (B) is in the above range, the adhesive force of the electroconductive pressure-sensitive adhesive layer can be more enhanced.

The polyisobutylene (B) may be generally solid at a normal temperature (23° C.), but may be flowable or semi-flowable and may have a formless shape (liquid or semi-fluid) at a normal temperature. Examples of a commercially available polyisobutylene that can be used as the polyisobutylene (B) include, but not limited to, “Tetrax” series (Tetrax 3T, 4T, 5T, 6T, etc.) manufactured by JXTG Energy Corporation, “Himol” series (Himol 4H, 5H, 5.5H, 6H, etc.) manufactured by JXTG Energy Corporation, and “OPPANOL B” series (OPPANOL B10, 11, 12, 13, 14, 15, etc.) manufactured by BASF.

The viscosity average molecular weights (Mv) of the polyisobutylene (A) and polyisobutylene (B) can each be determined from a viscosity measured by using an Ubbelohde viscometer or the like with the Schulz-Blaschke equation and the Mark-Howink-Sakurada equation. Specifically, the relational expression between the viscosity of the infinite dilution, that is, the intrinsic viscosity [n] and the molecular weight (Mark-Howink-Sakurada equation) is used to determine the molecular weight from an experimental value of the intrinsic viscosity. An isooctane solution of the polyisobutylene is prepared, and based on the flowing time with a capillary I at 20° C. measured by using an Ubbelohde viscometer, the Staudinger index Jo is calculated according to the Schulz-Blaschke equation. The viscosity average molecular weight (Mv) is calculated by using the Jo value with the Mark-Howink-Sakurada equation.

The Staudinger index Jo (cm³/g) is calculated from the flowing time at 20° C. measured with the capillary I of the Ubbelohde (Ubbelohde) viscometer.

$$Jo = η sp / c ( 1 + 0.31 \times η sp ) {cm}^{3} / g ( Schulz - Blachke equation )$$

$$η sp = t / to - 1 ( specific viscosity )$$

$$t = flowing time of solution ( Hagenbach - Couette correction value )$$

$$to = flowing time of solvent ( Hagenbach - Couette correction value )$$

$$c = concentration of solution ( g / {cm}^{3} )$$

The viscosity average molecular weight Mv can be calculated according to the following relational expression.

$$Jo = 3.06 \times 1 {0}^{- 2} {Mv}^{0.65}$$

In addition, as the viscosity average molecular weights (Mv) of the polyisobutylene (A) and the polyisobutylene (B), values shown in the “OPPANOL” product catalogue from BASF and the “Tetrax” product cataloguer from JXTG Energy Corporation can be used.

In the electroconductive pressure-sensitive adhesive layer, the ratio of the polyisobutylene (A) and the polyisobutylene (B) contained may be any ratio that gives a good balance between the adhesive property and the cohesive property. The weight ratio [(A)/(B)] of the polyisobutylene (A) to the polyisobutylene (B) contained may be in the range of 1/9 to 9/1, in the range of 3/7 to 8/2, or in the range of 5/5 to 7/3. When the ratio of the polyisobutylene (A) to the polyisobutylene (B) contained is in the above range, an electroconductive pressure-sensitive adhesive tape having a more superior adhesive force while maintaining a high swelling resistance to an electrolyte layer can be obtained.

The rubber component may contain the polyisobutylene (A) and the polyisobutylene (B) as main components, and in particular, the total amount of the polyisobutylene (A) and the polyisobutylene (B) in the rubber component may be 90% by weight or more, 95% by weight or more, 98% by weight or more, or 100% by weight so that the rubber component is constituted of the polyisobutylene (A) and the polyisobutylene (B). When the total amount of the polyisobutylene (A) and the polyisobutylene (B) in the rubber component is in the above range, the effect of one or more embodiments of the present invention achieved by using the polyisobutylene (A) and the polyisobutylene (B) together can be exhibited more.

The content of each of the polyisobutylene (A) and the polyisobutylene (B) contained in the electroconductive pressure-sensitive adhesive layer can be selected according to the content of the rubber component contained in the electroconductive pressure-sensitive adhesive layer and the ratio thereof as described above. For example, the content of the polyisobutylene (A) contained in the electroconductive pressure-sensitive adhesive layer may be 3% by weight to 90% by weight, 5% by weight to 70% by weight, or 10% by weight to 50% by weight. In addition, the content of the polyisobutylene (B) contained in the electroconductive pressure-sensitive adhesive layer may be 3% by weight to 90% by weight, 5% by weight to 70% by weight, or 10% by weight to 50% by weight.

The rubber component may contain or may not contain, besides the polyisobutylene (A) and the polyisobutylene (B), an optional rubber. When an optional rubber is contained, the optional rubber may be one that does not impair the function of the polyisobutylene (A) and the polyisobutylene (B), or a rubber that contains substantially no styrene backbone and no unsaturated hydrocarbon. Examples of the optional rubber include a polyisobutylene (C) that has a viscosity average molecular weight outside the ranges of the viscosity average molecular weights of the polyisobutylene (A) and the polyisobutylene (B), a copolymer of isobutylene and another monomer (isobutylene copolymer), such as butyl rubber, and a silicone rubber.

### Tackifying Resin

Besides the rubber component containing the polyisobutylene (A) and the polyisobutylene (B), the electroconductive pressure-sensitive adhesive layer may or may not contain a tackifying resin. When the electroconductive pressure-sensitive adhesive layer further contain a tackifying resin, it is possible to further enhance the adhesive force by the combination use of the polyisobutylene (B) and the tackifying resin while enhancing the swelling resistance to an electrolyte layer by the polyisobutylene rubber (A) contained in the electroconductive pressure-sensitive adhesive layer, and it is possible to make the achievement of both the adhesive property and the swelling resistance to an electrolyte layer further superior. On the other hand, when the electroconductive pressure-sensitive adhesive layer contains no tackifying resin, it is possible to enhance the workability in sticking to an adherend, such as an electrode or an electrolyte layer, while achieving both the swelling resistance to an electrolyte layer and the adhesive force, and it is possible to prevent damage of the adherend in re-sticking or the like.

The tackifying resin may be solid in normal temperature, and in particular, the softening point may be 80° C. or higher, 85° C. or higher, 90° C. or higher, or 100° C. or higher. In addition, the upper limit of the softening point of the tackifying resin is not particularly limited, but from the viewpoint of thermal durability and the like, may be 160° C. or lower, 150° C. or lower, or 130° C. or lower. When the electroconductive pressure-sensitive adhesive layer contains a tackifying resin that has such a high softening point, it is possible to impart a superior swelling resistance, adhesive property, and thermal durability to the electroconductive pressure-sensitive adhesive layer. More specifically, the range of the softening point may be 80° C. or higher and 160° C. or lower, 85° C. or higher and 155° C. or lower, or 90° C. or higher and 150° C. or lower, and, since a superior thermal durability as well as a further superior swelling resistance and adhesive property can be achieved, the range of the softening point may be 100° C. or higher and 130° C. or lower.

The softening point of the tackifying resin refers to a value measured by a method defined in JISK2207 (ring and ball method).

The tackifying resin may have a small content of aromatic rings and unsaturated hydrocarbons (double bonds), or may contain no aromatic ring and no unsaturated hydrocarbon (double bond). It is because the swelling property of the electroconductive pressure-sensitive adhesive layer is likely to be affected by the presence of aromatic rings and double bonds contained in the electroconductive pressure-sensitive adhesive layer.

The tackifying resin can be selected from among natural resins and synthetic resins that are known as a tackifying resin to be used in a rubber-based pressure-sensitive adhesive, and examples thereof include a petroleum resin, a rosin resin, a terpene resin, a phenol resin, a coal resin, and a xylene resin. As the tackifying resin, one kind may be used alone or two or more kinds may be used in combination. Among them, a petroleum resin is preferred in that it shows a good compatibility with polyisobutylene and can enhance the cohesive force of the electroconductive pressure-sensitive adhesive layer more.

Examples of the petroleum resin include an aliphatic hydrocarbon resin, an aromatic hydrocarbon resin, an aliphatic-aromatic copolymer hydrocarbon resin, an alicyclic hydrocarbon resin, an aliphatic-alicyclic hydrocarbon resin, a hydrogenated petroleum resin, a coumarone resin, and a coumarone-indene resin.

Examples of the aliphatic hydrocarbon resin include polymers obtained by using only one kind or two kinds of olefines having 4 to 5 carbon atoms, such as butene-1, isobutylene, and pentene-1, and dienes having 4 to 5 carbon atoms, such as butadiene, piperylene (1,3-pentadiene), and isoprene. Among them, C4 petroleum resins and C5 petroleum resins obtained from butadiene, piperylene, pentene, pentadiene, isoprene, and other fractions are preferred.

Examples of the aromatic hydrocarbon resin include polymers obtained by using only one kind or two or more kinds of vinyl group-containing aromatic hydrocarbons having 8 to 10 carbon atoms, such as styrene, vinyltoluene, methylstyrene, indene, and methylindene. Among them, C9 petroleum resins obtained from vinyltoluene, indene, and other fractions are preferred.

Example of the aliphatic-aromatic copolymer hydrocarbon resin include a styrene-olefine copolymer, a C5/C9 petroleum resin which is a copolymer of a C5 petroleum resin and a C9 petroleum resin, and a hydrogenated C5/C9 petroleum resin. As a product of the aliphatic-aromatic copolymer hydrocarbon resin, for example, Escorez 2101 (manufactured by Tonex), Quintone G115 (manufactured by ZEON CORPORATION), or Hercotac 1149 (manufactured by Rika Hercules) can be used.

Examples of the alicyclic hydrocarbon resin include an alicyclic hydrocarbon resin obtained by cyclization-dimerization of an aliphatic hydrocarbon resin, followed by polymerization, a polymer of a cyclic diene compound (cyclopentadiene, dicyclopentadiene, ethylidenenorbornene, dipentene, ethylidenebicycloheptene, vinylcycloheptene, tetrahydroindene, vinylcyclohexene, limonene, or the like), or a hydrogenated product thereof, and an alicyclic hydrocarbon resin obtained by hydrogenating an aromatic ring of the aromatic hydrocarbon resin or the aliphatic-aromatic copolymer hydrocarbon resin. In addition, examples of the aliphatic-alicyclic hydrocarbon resin include a hydrogenated C5/C9 petroleum resin obtained by hydrogenating a C5/C9 petroleum resin.

Examples of a product of the alicyclic hydrocarbon resin include ARKON P type (hydrogenated petroleum resin, manufactured by ARAKAWA CHEMICAL INDUSTRIES, LTD.), Rigalite R101 (manufactured by Rika Fine-tech Inc.), and T-REZ H series (hydrogenated dicyclopentadiene-based hydrogenated alicyclic hydrocarbon resin, manufactured by ENEOS).

Among them, the petroleum resin may be a hydrocarbon resin having no unsaturated bond (that is, saturated hydrocarbon resin). In addition, the petroleum resin may be a hydrocarbon resin having no aromatic ring. When the cohesive property of the electroconductive pressure-sensitive adhesive layer is further enhanced, the tackiness can also be enhanced, and even when charging and discharging of a cell are repeated in a state where the cell is in contact with or immersed in an electrolyte layer, an oxidation reaction or a decomposition reaction can be less likely to occur and the cycle characteristics of the cell can be stabilized. For example, the hydrocarbon resin having no unsaturated bond and no aromatic ring may be a saturated hydrocarbon resin selected from an aliphatic hydrocarbon resin, an alicyclic hydrocarbon resin, an aliphatic-alicyclic hydrocarbon resin, and a hydrogenated resin thereof. The tackifying resin may be one or two or more selected therefrom.

The weight average molecular weight of the tackifying resin is not particularly limited as long as the electroconductive pressure-sensitive adhesive tape of one or more embodiments of the present invention can exhibit a desired bonding strength, but may be 100 or more and 100,000 or less, 200 or more and 50,000 or less, or 300 or more and 10,000 or less. When such a tackifying resin that has a weight average molecular weight in the above range is used, the electroconductive pressure-sensitive adhesive tape of one or more embodiments of the present invention can further enhance the adhesive force by the combination use of the polyisobutylene rubber (A) and the tackifying resin while maintaining a good swelling resistance of the electroconductive pressure-sensitive adhesive layer by the polyisobutylene rubber (B).

The weight average molecular weight of the tackifying resin is a value based on standard polystyrenes which is measured in the following conditions using gel permeation chromatograph (GPC).
Measurement apparatus: gel permeation chromatography (SC-8020 manufactured by Tosoh Corporation)
Column: high molecular weight column TSKgel GMHHR-H
Solvent: tetrahydrofuran (THF)
Detector: refractive index detector (RI)
Column temperature (measuring temperature): 40° C.
Eluent: tetrahydrofuran (THF)
Flow rate: 1.0 mL/min
Sample injection: 100 μL
Sample concentration: 0.4% by weight of tetrahydrofuran (THF) solution
Standard samples: standard polystyrenes

In the electroconductive pressure-sensitive adhesive layer, the content of the tackifying resin can be 0 part by weight or more and 80 parts by weight or less relative to 100 parts by weight of the rubber component, and may be 20 parts by weight or more and 80 parts by weight or less, 25 parts by weight or more and 60 parts by weight or less, or 30 parts by weight or more and 40 parts by weight or less.

In addition, the content of the tackifying resin can be 0 part by weight or more and 80 parts by weight or less relative to 100 parts by weight of the total amount of the polyisobutylene (A) and the polyisobutylene (B), and may be 20 parts by weight or more and 80 parts by weight or less, 25 parts by weight or more and 60 parts by weight or less, or 30 parts by weight or more and 40 parts by weight or less. When the content of the tackifying resin is within the above range, the electroconductive pressure-sensitive adhesive tape of one or more embodiments of the present invention can further enhance the adhesive force by the combination use of the polyisobutylene rubber (A) and the tackifying resin while maintaining a good swelling resistance of the electroconductive pressure-sensitive adhesive layer by the polyisobutylene rubber (B), and can achieve both a further superior adhesive property and a superior swelling resistance. Note that, when the electroconductive pressure-sensitive adhesive layer and the rubber-based pressure-sensitive adhesive contain two or more tackifying resins, the amount of the tackifying resin refers to the total amount of the two or more tackifying resins.

### Optional Components

The electroconductive pressure-sensitive adhesive layer and the rubber-based pressure-sensitive adhesive contain at least the rubber component described above, and can contain an optional component as required. Examples of the optional component include additives, such as an antioxidant, an ultraviolet absorber, a filler, a polymerization inhibitor, a surface conditioning agent, an antistatic agent, a defoaming agent, a viscosity modifier, a light-resistant stabilizer, a weather resistant stabilizer, a heat resistant stabilizer, an antioxidant, a leveling agent, an organic pigment, an inorganic pigment, a pigment disperser, a plasticizer, a softening agent, a flame retardant, a metal deactivator, silica beads, and organic beads; and inorganic fillers other than electroconductive particles.

### (2) Electroconductive Particles

The electroconductive particles contained in the electroconductive pressure-sensitive adhesive layer is not particularly limited as long as they are particles having electrical conductivity, and can be appropriately selected according to the purpose. Examples of the electroconductive particles that can be used include a metal, such as gold, silver, copper, nickel, or aluminum, an alloy, such as solder or stainless steel, particles of metal powder, such as metal oxide; particles of electroconductive resin, such as carbon or graphite; metal-covered particles in which the surface of resin beads or solid or hollow glass beads are covered with a metal (metal-coated particles); and metal composite particles in which the surface of metal particles is covered with another metal. As the electroconductive particles, one kind may be used alone or two or more kinds may be used in combination.

Among them, since the electrical conductivity and the adhesive property are easily both achieved, the electroconductive particles may be metal particles, or metal powder particles selected from the group consisting of nickel powder particles, copper powder particles, and silver powder particles because of the superior electrical conductivity, adhesive property, and productivity. Further preferable examples thereof include surface-needle-shape nickel particles which are produced by a carbonyl method and has many needle forms on the surface of particles, particles obtained by smoothening the surface-needle-shape particles into spherical shape, and a copper powder or silver powder produced by an ultra-high pressure swirl water atomizing method.

The shape of the electroconductive particles is not particularly limited and can be appropriately selected according to the purpose, and examples thereof include a spherical shape, a surface needle shape, a filament shape (rosary shape), and a flaky shape (thin leaf shape). Among them, from the viewpoints of securing the pressure-sensitive adhesive force and easily forming an electroconductive path by the metal particles in the electroconductive pressure-sensitive adhesive layer, a spherical shape or a filament shape is preferred.

The particle diameter of the electroconductive particles can be such a value that the electroconductive pressure-sensitive adhesive layer can exhibit a desired electrical conductivity and can be appropriately selected according to the purpose. For example, the particle diameter d50 of the electroconductive particles may be 4 μm or more and 30 μm or less, or 10 μm or more and 20 μm or less. In addition, the particle diameter d90 of the electroconductive particles may be 8 μm or more and 50 μm or less, or 20 μm or more and 40 μm or less. When two or more kinds of electroconductive particles are mixed in the electroconductive pressure-sensitive adhesive layer, it is preferred that the particle diameters d50 and d90 after mixing are in the above respective ranges.

The particle diameters d50 and d90 of the electroconductive particles refer to the 50% cumulative volume particle diameter and the 90% cumulative volume particle diameter in a volume particle size distribution and are measured by a laser diffraction analysis and scattering method. Examples of the measurement apparatus include Microtrac MT3000II manufactured by NIKKISO CO., LTD. and Laser Diffraction Particle Size Distribution Analyzer SALD-3000 manufactured by Shimadzu Corporation. When two or more kinds of electroconductive particles are contained, the particle diameters are calculated based on a distribution of a mixture of all the electroconductive particles.

Examples of the method of adjustment into the particle diameters d50 and d90 of the electroconductive particles include a method of pulverizing the electroconductive particles with a jet mill and a sieving method.

The ratio of the particle diameter d50 of the electroconductive particles to the thickness of the electroconductive pressure-sensitive adhesive layer ([particle diameter d50 of electroconductive particles/thickness of electroconductive pressure-sensitive adhesive layer]) may be 50% to 150%, 60% to 120%, or 70 to 100%.

In addition, the ratio of the particle diameter d90 of the electroconductive particles to the thickness of the electroconductive pressure-sensitive adhesive layer ([particle diameter d90 of electroconductive particles/thickness of electroconductive pressure-sensitive adhesive layer]) may be 100 to 300%, 120 to 250%, or 150 to 200%.

When the ratios of the particle diameters d50 and d90 of the electroconductive particles to the thickness of the electroconductive pressure-sensitive adhesive layer are within the above ranges, respectively, the electroconductive pressure-sensitive adhesive tape of one or more embodiments of the present invention can achieve both a high adhesive force and a superior electrical conductivity.

In the electroconductive pressure-sensitive adhesive layer, the content of the electroconductive particles may be 0.1 part by weight or more and 100 parts by weight or less relative to 100 parts by weight of the rubber component, 0.5 parts by weight or more and 50 parts by weight or less, or 1 part by weight or more and 10 parts by weight or less. When the content of the electroconductive particles to the rubber component in the electroconductive pressure-sensitive adhesive layer is within the above range, the electroconductive pressure-sensitive adhesive layer can achieve both a high adhesive force and a superior electrical conductivity.

### (3) Electroconductive Pressure-Sensitive Adhesive Layer

The thickness of the electroconductive pressure-sensitive adhesive layer is not particularly limited as long as it is such a thickness that can exhibit a superior adhesive property and electrical conductivity, but may be 3 μm or more, 5 μm or more, or 10 μm or more. In addition, the thickness may be 50 μm or less, 30 μm or less, 25 μm or less, or 20 μm or less. More specifically, the range of the thickness can be 3 μm or more and 50 μm or less, can be, for example, 3 μm or more and 30 μm or less, for example, 5 μm or more and 25 μm or less, for example, 5 μm or more and 20 μm or less, and for example, 3 μm or more and 10 μm or less. When the thickness of the electroconductive pressure-sensitive adhesive layer is within the above range, it is possible to exhibit the swelling resistance to an electrolyte layer, and it is also possible to achieve both a superior adhesive property and electrical conductivity and a thin electroconductive pressure-sensitive adhesive tape.

The thickness of the electroconductive pressure-sensitive adhesive layer is an average value of thicknesses of 5 points apart at intervals of 100 mm in the longitudinal direction measured using a dial thickness gage type G manufactured by OZAKI MFG. CO., LTD.

Since the electroconductive pressure-sensitive adhesive layer contains the electroconductive particles, the electrical conductivity can be exhibited. The electroconductive pressure-sensitive adhesive layer may show a surface resistance value as described later in the section of “3. Electroconductive Pressure-Sensitive Adhesive Tape”.

The electroconductive pressure-sensitive adhesive layer is formed by the electroconductive pressure-sensitive adhesive containing the rubber component and the electroconductive particles. The method for preparing the electroconductive pressure-sensitive adhesive is not particularly limited as long as, in forming an electroconductive pressure-sensitive adhesive layer, electroconductive particles can be sufficiently dispersed throughout the layer formed, and a typical example thereof is a method in which the rubber component, a solvent, and the electroconductive particles, and the tackifying resin, optional additives, or the like according to the need, are dispersed with a dispersion agitator.

### 2. Optional Constitutional Member

The electroconductive pressure-sensitive adhesive tape of one or more embodiments of the present invention includes at least the electroconductive pressure-sensitive adhesive layer described above, and may include an optional constitutional member according to the specification of the tape.

### (1) Electroconductive Substrate

When the electroconductive pressure-sensitive adhesive tape of one or more embodiments of the present invention has an electroconductive pressure-sensitive adhesive layer on one surface or both surfaces of an electroconductive substrate, examples of the electroconductive substrate include a metal substrate, such as a metal film or a metal foil, a graphite substrate, an electroconductive resin substrate, an electroconductive nonwoven fabric, and an electroconductive woven fabric. Among them, from the viewpoint of the electrical conductivity, a metal substrate and an electroconductive nonwoven fabric are preferred.

The metal substrate may be any that is formed of a metal or an alloy, and examples thereof include a metal foil and a metal film. Among them, a metal foil is preferred in points of electrical conductivity, processability, and cost. The material of the metal substrate is not particularly limited, and examples thereof include metals, such as gold, silver, copper, aluminum, nickel, iron, and tin, and alloys thereof. Among them, in points of electrical conductivity, processability, and cost, aluminum or copper is preferred, copper is more preferred, and rolled copper foil is particularly preferred.

The metal substrate may have a plated layer on one surface or both surfaces thereof. When a plated layer is formed on a surface of a metal substrate, reduction in electrical conductivity, poor appearance, and the like due to corrosion can be prevented. Examples of the material of the plated layer include tin plating, silver plating, gold plating, and zinc plating. In addition, one surface or both surfaces of the metal substrate may also be subjected to a coupling treatment with a silane coupling agent or the like, a chromate treatment, or a rust prevention treatment with a benzotriazole compound or the like.

An example of the electroconductive nonwoven fabric substrate is a metal-plated nonwoven fabric in which a nonwoven fabric is plated with a metal. The nonwoven fabric may be any that is formed of a material that can be plated with a metal, and a common resin nonwoven fabric, glass nonwoven fabric, or the like can be used. A specific example is a polyester nonwoven fabric. Examples of the metal for plating the nonwoven fabric include copper, nickel, silver, platinum, and aluminum. Among them, copper or nickel is preferred in points of electrical conductivity and cost.

The electroconductive substrate may be subjected to a common surface treatment, for example, an oxidation treatment by a chemical or physical method, such as a chromic acid treatment, ozone exposure, flame exposure, high voltage electric shock exposure, or an ionizing radiation treatment, as required, for enhancing the adhesion with the electroconductive pressure-sensitive adhesive layer.

The thickness of the electroconductive substrate can be appropriately designed according to the electrical conductivity required for the electroconductive pressure-sensitive adhesive tape of one or more embodiments of the present invention and is not particularly limited, but, for example, may be 1 μm or more and 40 μm or less, 3 μm or more and 35 μm or less, or 6 μm or more and 25 μm or less. When the thickness of the electroconductive substrate is within the above range, the thickness of the electroconductive pressure-sensitive adhesive tape of one or more embodiments of the present invention can be reduced and the electroconductive pressure-sensitive adhesive tape can be superior in processability.

### (2) Release Liner

The electroconductive pressure-sensitive adhesive tape of one or more embodiments of the present invention may have a release liner on the pressure-sensitive adhesive surface thereof. When the electroconductive pressure-sensitive adhesive tape of one or more embodiments of the present invention is substrate-less, the electroconductive pressure-sensitive adhesive tape of one or more embodiments of the present invention can have a release liner on at least one of the opposite main surfaces of the electroconductive pressure-sensitive adhesive layer, or may have a release liner each on both the main surfaces. In addition, when the electroconductive pressure-sensitive adhesive tape of one or more embodiments of the present invention has an electroconductive substrate, the electroconductive pressure-sensitive adhesive tape can have a release liner at least on the surface of the electroconductive pressure-sensitive adhesive layer provided on one surface side of the electroconductive substrate, and may have a release liner each on the surfaces of the electroconductive pressure-sensitive adhesive layers respectively provided on both surfaces of the electroconductive substrate.

The release liner is not particularly limited and a common release line can be appropriately selected according to the purpose. As the release liner, a common one can be used, and examples thereof include papers, such as a kraft paper, a glassine paper, and a fine paper; polyolefin resins, such as polyethylene and polypropylene (for example, OPP, CPP), a resin film of a polyester resin (for example, polyethylene terephthalate) or the like; a laminated paper in which a paper and a resin film are laminated; a processed paper in which one surface or both surfaces of a paper subjected to a filling treatment with clay, polyvinyl alcohol, or the like is subjected to a release treatment with a silicone resin or the like.

### 3. Electroconductive Pressure-Sensitive Adhesive Tape

The total thickness of the electroconductive pressure-sensitive adhesive tape of one or more embodiments of the present invention is not particularly limited as long as a desired electrical conductivity and adhesive property can be achieved, and can be appropriately set according to the aspect of use, and for example, can be 100 μm or less, 65 μm or less, 50 μm or less, or 30 μm or less. When the total thickness of the electroconductive pressure-sensitive adhesive tape of one or more embodiments of the present invention is within the above range, it is possible to reduce the thickness while ensuring the adhesive property and electrical conductivity, which can contribute to reduction in the size and thickness of a cell or the like. In addition, a smaller total thickness of the electroconductive pressure-sensitive adhesive tape of one or more embodiments of the present invention is more desirable, but the lower limit thereof is not particularly limited as long as a desired electrical conductivity and adhesive property can be achieved, and for example, the total thickness can be 3 μm or more, 5 μm or more, 10 μm or more, or 20 μm or more. Specifically, the total thickness of the electroconductive pressure-sensitive adhesive tape can be 3 μm or more and 100 μm or less, 5 μm or more and 65 μm or less, 10 μm or more and 50 μm or less, or 20 μm or more and 30 um or less.

In particular, when the electroconductive pressure-sensitive adhesive tape of one or more embodiments of the present invention is of a substrate-less specification, the total thickness of the electroconductive pressure-sensitive adhesive tape may be the same as the thickness of the electroconductive pressure-sensitive adhesive layer as described above, and for example, may be 50 μm or less, 3 μm or more and 50 μm or less, 3 μm or more and 30 μm or less, 5 μm or more and 25 μm or less, 5 μm or more and 20 μm or less, 3 μm or more and 10 μm or less, or 10 μm or more and 25 μm or less. When the total thickness of the substrate-less electroconductive pressure-sensitive adhesive tape is within the above range, the both achievement of the adhesive property and electrical conductivity and the reduced thickness is more superior.

Note that the total thickness of the electroconductive pressure-sensitive adhesive tape does not include the thickness of the release liner(s).

The smaller the change in weight from before to after immersion in a liquid (electrolytic solution or nonaqueous solvent) for a certain period of time is, the more superior the swelling resistance of the electroconductive pressure-sensitive adhesive tape to an electrolyte layer is. The electroconductive pressure-sensitive adhesive tape of one or more embodiments of the present invention may show a weight change rate (swelling rate) of the electroconductive pressure-sensitive adhesive layer from before to after leaving the electroconductive pressure-sensitive adhesive tape immersed in dimethyl carbonate in an environment of 23° C. and 50% RH for 1 week of 10% by weight or less, 8% by weight or less, 5% by weight or less, or 3% by weight or less. In addition, the electroconductive pressure-sensitive adhesive tape of one or more embodiments of the present invention may show a weight change rate (swelling rate) of the electroconductive pressure-sensitive adhesive layer from before to after leaving the electroconductive pressure-sensitive adhesive tape immersed in propylene carbonate in an environment of 23° C. and 50% RH for 1 week of 10% by weight or less, and, in particular, 8% by weight or less, 5% by weight or less, 3% by weight or less, or 1% by weight or less.

The weight change rate (swelling rate) of the electroconductive pressure-sensitive adhesive layer from before to after being immersed in dimethyl carbonate or propylene carbonate can be determined by the following method. When the electroconductive pressure-sensitive adhesive tape of one or more embodiments of the present invention is of a substrate-less specification, first, a release liner(s) of the electroconductive pressure-sensitive adhesive tape is/are detached and only the electroconductive pressure-sensitive adhesive layers are stacked to produce a specimen having a length of 10 mm, a width of 10 mm, and a thickness of 1 mm. The weight (G1) of the specimen before immersion is measured in advance, the specimen is immersed in dimethyl carbonate or propylene carbonate in an environment of 23° C. and 50% RH for 1 week, then, dimethyl carbonate or propylene carbonate remaining on the surface of the specimen is wiped off, and the weight (G2) after drying at 23° C. for 4 hours is measured to calculate the weight change rate according to the following equation.

$$Weight change rate of electroconductive pressure - sensitive adhesive layer from before to after immersion ( swelling rate [ \% by weight ] ) = \{ ( G 2 / G 1 ) \times 100 \} - 100$$

In addition, when the electroconductive pressure-sensitive adhesive tape of one or more embodiments of the present invention has a substrate, first, the electroconductive pressure-sensitive adhesive layer is removed from the electroconductive pressure-sensitive adhesive tape to leave only the electroconductive substrate having a length of 10 mm and a width of 10 mm, and the weight (G3) of the electroconductive substrate is measured. The same electroconductive pressure-sensitive adhesive tape as one used for measuring the weight (G3) of the electroconductive substrate is used to measure the thickness (T1) of the electroconductive pressure-sensitive adhesive tape after detaching the release liner(s). Subsequently, the electroconductive pressure-sensitive adhesive tapes after detaching the release liner(s) are stacked to produce a specimen (T2) having a length of 10 mm, a width of 10 mm, and a thickness of about 10 mm. Subsequently, the weight (G1) of the specimen before immersion is measured in advance, the specimen is immersed in dimethyl carbonate or propylene carbonate in an environment of 23° C. and 50% RH for 1 week, then dimethyl carbonate or propylene carbonate remaining on the surface of the specimen is wiped off, and the weight (G2) after drying at 23° C. for 4 hours is measured to calculate the weight change rate according to the following equation.

$$Weight change rate of electroconductive pressure - sensitive adhesive layer from before to after immersion ( swelling rate [ \% by weight ] ) = \{ ( G 2 - ( G 3 \times T 2 / T 1 ) ) / ( G 1 - ( G 3 \times T 2 / T 1 ) ) \times 1 \; 00 \} - 100$$

Dimethyl carbonate and propylene carbonate are commonly used each alone or in mixture as a nonaqueous solvent for dissolving an electrolyte. When the weight change rates of the electroconductive pressure-sensitive adhesive layer from before to after immersion in the nonaqueous solvents are within the above respective ranges, the electroconductive pressure-sensitive adhesive tape of one or more embodiments of the present invention can prevent change in weight due to swelling similarly also when being in contact with or immersed in an electrolyte layer containing the nonaqueous solvents, and can exhibit swelling resistance. In particular, although dimethyl carbonate is more liable to enter the interior of an electroconductive pressure-sensitive adhesive layer and is more liable to swell than other carbonate ester solvents, such as propylene carbonate, according the electroconductive pressure-sensitive adhesive tape of one or more embodiments of the present invention, it is possible to exhibit a higher swelling resistance because of the weight change rate from before to after immersion in dimethyl carbonate falling within the above range. The reason why dimethyl carbonate is more liable to enter an electroconductive pressure-sensitive adhesive layer than other carbonate ester solvents is not clear, but it is supposedly because dimethyl carbonate has a higher compatibility with a pressure-sensitive adhesive layer in terms of the molecular structure thereof.

The electroconductive pressure-sensitive adhesive tape of one or more embodiments of the present invention may have a 180-degree peeling adhesive force as measured according to JISZ2037 of 5 N/20 mm or more, 10 N/20 mm or more, or 12 N/20 mm or more. The electroconductive pressure-sensitive adhesive tape, which has a 180° C. peeling adhesive force within the above range, can firmly adhere to an adherend and occurrence of detachment from an adherend, such as an electrolyte layer or an electrode, can be prevented.

The 180-degree peeling adhesive force refers to a strength as measured according to JISZ2037 in which an electroconductive pressure-sensitive adhesive tape is cut into a width of 20 mm, and one surface is backed with a PET film. The tape with backing is then pressure bonded onto a stainless steel (SUS) plate with one reciprocation of a 2-kg roller in an environment of a temperature of 23° C. and a moisture of 50% RH and is then left for 1 hour, and thereafter, the strength during peeling in a direction of 180° at a rate of 300 mm/min is measured. When the electroconductive pressure-sensitive adhesive tape is of a one-side pressure-sensitive adhesion specification, the backing is not necessary.

The surface resistance value per 6.25 cm² (m (2/6.25 cm²) of the electroconductive pressure-sensitive adhesive tape of one or more embodiments of the present invention may be less than 100 mΩ/6.25 cm², 50 mΩ/6.25 cm² or less, or 30 mΩ/6.25 cm² or less. When the surface resistance value of the electroconductive pressure-sensitive adhesive tape is within the above range, a high electrical conductivity can be exhibited.

The surface resistance value of the electroconductive pressure-sensitive adhesive tape is a value measured as follows: an electroconductive pressure-sensitive adhesive tape is cut into a size of 25 mm width×25 mm width, which is interposed between two copper plates and is pressure bonded thereto with one reciprocation of a 2.0-kg roller at a normal temperature so as to give each bonding area of 6.25 cm², and after leaving it for 1 hour in an environment of 23° C. and 50% RH, a terminal is connected to an end (a portion that is not bonded) of each of the two copper plates in the same environment, and a current of 10 μA is allowed to flow with a milliohmmeter (manufactured by NF CORPORATION) to measure the resistance value.

### 4. Production Method

The electroconductive pressure-sensitive adhesive tape of one or more embodiments of the present invention can be produced using a common method, and the production method is not particularly limited, but, for example, the electroconductive pressure-sensitive adhesive tape can be produced by preparing an electroconductive pressure-sensitive adhesive that contains a rubber component containing at least the polyisobutylene (A) and the polyisobutylene (B) and electroconductive particles, and applying the electroconductive pressure-sensitive adhesive on a surface of a release liner or, when the electroconductive pressure-sensitive adhesive tape includes an electroconductive substrate, on a surface of the electroconductive substrate, with a roll coater or a die coater, followed by drying.

The electroconductive pressure-sensitive adhesive tape of one or more embodiments of the present invention, when having an electroconductive pressure-sensitive adhesive layer directly on one surface or both surfaces of an electroconductive substrate, can be produced by a transferring method in which an electroconductive pressure-sensitive adhesive layer formed on a release liner and an electroconductive substrate are bonded to each other. In bonding the electroconductive pressure-sensitive adhesive layer formed on the release liner and the electroconductive substrate, thermal lamination may be used from the viewpoint of imparting a superior adhesion between the electroconductive substrate and the electroconductive pressure-sensitive adhesive layer. The temperature of the thermal lamination may be 60° C. or higher and 150° C. or lower, 70° C. or higher and 130° C. or lower, or 80° C. or higher and 110° C. or lower in terms of adhesion and prevention of shrinkage of the electroconductive substrate.

When the electroconductive pressure-sensitive adhesive layer of the electroconductive pressure-sensitive adhesive tape of one or more embodiments of the present invention is to be provided on a surface of an electroconductive substrate via another layer, a method can be used in which an electroconductive pressure-sensitive adhesive layer is provided on the other layer in place of an electroconductive substrate by the method described above.

### 5. Use Purpose

The electroconductive pressure-sensitive adhesive tape of one or more embodiments of the present invention, which is superior in swelling resistance and can achieve both a high adhesive property and a high electrical conductivity, can be suitably used for a cell, a battery, and the like to be used for, for example, an electronic device or an automobile. That is, the electroconductive pressure-sensitive adhesive tape of one or more embodiments of the present invention is useful as an electroconductive pressure-sensitive adhesive tape for a cell or a battery. The cell or battery is not limited to a cell that has an electrolyte layer that is a liquid layer, such as a lithium-ion secondary battery, and the electroconductive pressure-sensitive adhesive tape of one or more embodiments of the present invention can be used in a solid electrolyte layer of an all-solid-type cell or the like or a cell or the like that has an electrolyte layer that is a semi-solid layer.

In addition, the part in which the electroconductive pressure-sensitive adhesive tape of one or more embodiments of the present invention is used is not particularly limited, but, because of capability of exhibiting electrical conductivity, the electroconductive pressure-sensitive adhesive tape of one or more embodiments of the present invention is suitably used in a part in which conduction is needed in various cells. The electroconductive pressure-sensitive adhesive tape of one or more embodiments of the present invention, which is superior in swelling resistance to an electrolyte layer, may be used in the vicinity of an electrolyte layer. Examples of the vicinity of an electrolyte layer include a position to be in contact with an electrolyte layer, a position to be immersed in an electrolyte layer that is a liquid layer, or a position that has such a possibility. In particular, the electroconductive pressure-sensitive adhesive tape of one or more embodiments of the present invention may be used in contact with an electrolyte layer. When the electrolyte layer is a solid layer, the electroconductive pressure-sensitive adhesive tape of one or more embodiments of the present invention may be used in a state attached to the electrolyte layer. Specific examples of the part in which the electroconductive pressure-sensitive adhesive tape of one or more embodiments of the present invention is used include a part between a positive electrode and/or a negative electrode and an electrolyte layer in an electrode and a part between an active material layer and a collector in a positive electrode or negative electrode, but the part is not limited thereto and the electroconductive pressure-sensitive adhesive tape of one or more embodiments of the present invention is useful for fixing two members through which conduction is to be given.

The electrolyte layer may be a liquid layer made of an electrolytic solution in which an electrolyte is dissolved in a nonaqueous solvent, may be an electrolyte layer made of a polymer gel impregnated with the electrolytic solution, or may be a solid electrolyte layer that contains substantially no nonaqueous solvent and is constituted of an electrolyte.

The electrolyte contained in the electrolyte layer is not particularly limited, and examples thereof include an inorganic electrolyte and an organic electrolyte. As the electrolyte, for example, a known lithium salt or the like can be used, and specific examples thereof include LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, and (C₂F₅SO₂)NLi. One of them can be used alone or two or more thereof can be used in mixture.

In addition, examples of the electrolyte layer include a gel-like polymer electrolyte in which a polymer electrolyte, such as polyethylene oxide or polyacrylonitrile, is impregnated with an electrolytic solution, and inorganic solid electrolytes, such as lithium sulfide, LiI, Li₃N, and an Li₂S-P₂S₅ glass ceramic.

The nonaqueous solvent contained in the electrolyte layer is not particularly limited as long as it can be used together with an electrolyte, and examples thereof include lactone solvents, such as γ-butyrolactone, γ-valerolactone, δ-valerolactone, and e-caprolactone, chain or cyclic carbonate ester solvents, such as ethylene carbonate, propylene carbonate, butylene carbonate, dimethyl carbonate, ethyl methyl carbonate, and diethyl carbonate, ether solvents, such as 1,2-dimethoxyethane, 1-ethoxy-2-methoxyethane, 1,2-diethoxyethane, tetrahydrofuran, and 2-methyltetrahydrofuran, a nitrile solvent, such as acetonitrile, a sulfolane solvent, a phosphoric acid, a phosphorate ester solvent, and a nonaqueous solvent, such as a pyrrolidone. One solvent may be used alone or two or more solvents may be used in mixture. Among them, since a high ionic conductivity is easily obtained and the temperature range in use is wide, chain or cyclic carbonate ester solvents, such as dimethyl carbonate, ethylene carbonate, propylene carbonate, diethyl carbonate, and dimethyl carbonate, are preferred. One of them can be used alone or two or more thereof can be used in mixture. In addition, an additive can be incorporated and used in an electrolytic solution.

One or more embodiments of the present invention is not to be limited to the embodiments. One or more embodiments are merely an example, and any aspect that has substantially the same configuration and the same effects as the technical idea defined in the claims of one or more embodiments of the present invention is encompassed in the technical scope of one or more embodiments of the present invention.

### EXAMPLES

Examples of one or more embodiments of the present invention will be described below, but one or more embodiments of the present invention are not to be limited to the examples.

### Preparation of Electroconductive Pressure-Sensitive Adhesive Composition

Electroconductive pressure-sensitive adhesive compositions used in Examples and Comparative Examples were prepared in the following method. Note that materials used in preparing the electroconductive pressure-sensitive adhesive compositions are as follows. The viscosity average molecular weights of polyisobutylene rubbers, the softening points of tackifying resins, and particle diameters d50 and d90 of electroconductive particles are measured by the respective methods described above.
Polyisobutylene rubber (A1): “OPPANOL N50SF” manufactured by BASF Japan, viscosity average molecular weight: 425,000, solid
Polyisobutylene rubber (A2): “OPPANOL N80” manufactured by BASF Japan, viscosity average molecular weight: 800,000, solid
Polyisobutylene rubber (B1): “Tetrax 6T” manufactured by ENEOS, viscosity average molecular weight; 60,000, solid
Polyisobutylene rubber (B2): “Tetrax 3T” manufactured by ENEOS, viscosity average molecular weight; 30,000, solid
Tackifying resin (1): hydrogenated dicyclopentadiene, “T-REZ HA-125” manufactured by ENEOS, softening point: 125° C.
Tackifying resin (2): hydrogenated dicyclopentadiene, “T-REZ HA-85” manufactured by ENEOS, softening point: 85° C.
Nickel powder (1): “NI123” manufactured by FUKUDA METAL FOIL & POWDER CO.,

LTD., d50:11.7 um, d90:39.4 μm
Antioxidant (1): hindered phenol antioxidant, Irganox 1010 manufactured by BASF Japan

### Preparation Example 1

As a rubber component, 90 parts by weight of the polyisobutylene rubber (A1) and 10 parts by weight of the polyisobutylene rubber (B1), and 36 parts by weight of the tackifying resin (1) were mixed and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition A.

### Preparation Example 2

As a rubber component, 70 parts by weight of the polyisobutylene rubber (A1) and 30 parts by weight of the polyisobutylene rubber (B1), and 36 parts by weight of the tackifying resin (1) were mixed and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition B.

### Preparation Example 3

As a rubber component, 50 parts by weight of the polyisobutylene rubber (A1) and 50 parts by weight of the polyisobutylene rubber (B1), and 36 parts by weight of the tackifying resin (1) were mixed and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition C.

### Preparation Example 4

As a rubber component, 30 parts by weight of the polyisobutylene rubber (A1) and 70 parts by weight of the polyisobutylene rubber (B1), and 36 parts by weight of the tackifying resin (1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition D.

### Preparation Example 5

As a rubber component, 10 parts by weight of the polyisobutylene rubber (A1) and 90 parts by weight of the polyisobutylene rubber (B1), and 36 parts by weight of the tackifying resin (1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition E.

### Preparation Example 6

As a rubber component, 50 parts by weight the polyisobutylene rubber (A1) and 50 parts by weight of the polyisobutylene rubber (B2), and 36 parts by weight of the tackifying resin (1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition F.

### Preparation Example 7

As a rubber component, 70 parts by weight of the polyisobutylene rubber (A1) and 30 parts by weight the polyisobutylene rubber (B2), and 36 parts by weight of the tackifying resin (1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition G.

### Preparation Example 8

As a rubber component, 50 parts by weight of the polyisobutylene rubber (A1) and 50 parts by weight of the polyisobutylene rubber (B1), and 36 parts by weight of the tackifying resin (2) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition H.

### Preparation Example 9

As a rubber component, 50 parts by weight of the polyisobutylene rubber (A1) and 50 parts by weight of the polyisobutylene rubber (B1), and 71.8 parts by weight of the tackifying resin (2) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition I.

### (Preparation Example 10

As a rubber component, 50 parts by weight of the polyisobutylene rubber (A2) and 50 parts by weight of the polyisobutylene rubber (B1), and 36 parts by weight of the tackifying resin (1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition J.

### Preparation Example 11

As a rubber component, 50 parts by weight of the polyisobutylene rubber (A1) and 50 parts by weight of the polyisobutylene rubber (B1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition K.

### Preparation Example 12

As a rubber component, 100 parts by weight of the polyisobutylene rubber (A1), and 36 parts by weight of the tackifying resin (1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition L.

### Preparation Example 13

As a rubber component, 100 parts by weight of the polyisobutylene rubber (A1) was dissolved in 400 parts by weight of toluene. To the obtained solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition M.

### Preparation Example 13

As a rubber component, 100 parts by weight of the polyisobutylene rubber (B1), and 36 parts by weight of the tackifying resin (1) were mixed, and were dissolved in 400 parts by weight of toluene as a solvent to obtain a mixed solution. To the mixed solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition N.

### Preparation Example 15

As a rubber component, 100 parts by weight of the polyisobutylene rubber (B1) was dissolved in 400 parts by weight of toluene. To the obtained solution, 1 part by weight of the nickel powder (1), 0.9 parts by weight of the antioxidant (1), and 0.6 parts by weight of benzotriazole, relative to 100 parts by weight of the rubber component, were added, and the solid concentration was adjusted to 25% by weight with toluene, followed by mixing with a dispersion agitator, thus preparing an electroconductive pressure-sensitive adhesive composition O.

### Examples 1 to 11

As shown in Table 1 shown below, each of the electroconductive pressure-sensitive adhesive compositions A to K obtained in Preparation Examples 1 to 11 was applied on a release liner (PET38×1, A3, manufactured by NIPPA) with a comma coater so as to give a thickness after drying of 10 μm, and was dried in a dryer at 80° C. for 2 minutes, and then, another release liner (PET38×1, A3, manufactured by NIPPA) was bonded to the surface of the coating film after drying, thus producing an electroconductive pressure-sensitive adhesive tape.

### Comparative Examples 1 to 4

As shown in Table 2 shown below, each of the electroconductive pressure-sensitive adhesive compositions L to O obtained in Preparation Examples 12 to 15 was applied on a release liner (PET38×1, A3, manufactured by NIPPA) with a comma coater so as to give a thickness after drying of 10 μm, and was dried in a dryer at 80° C. for 2 minutes, and then another release liner (PET38×1, A3, manufactured by NIPPA) was bonded to the surface of the coating film after drying, thus producing an electroconductive pressure-sensitive adhesive tape.

Note that, in the compositional formulations of the electroconductive pressure-sensitive adhesive layers in the tables, descriptions of the antioxidant and benzotriazole are omitted.

### Evaluation

Various characteristics of the electroconductive pressure-sensitive adhesive tapes obtained in Examples 1 to 11 and Comparative Examples 1 to 4 were evaluated as follows.

### Average Thickness of Electroconductive Pressure-Sensitive Adhesive Tape

The average thickness of each electroconductive pressure-sensitive adhesive tape is an average value obtained by measuring thicknesses of the electroconductive pressure-sensitive adhesive tape after detaching the release liners (only the electroconductive pressure-sensitive adhesive layer) at 5 points apart at intervals of 100 mm in the longitudinal direction using a dial thickness gage G type manufactured by OZAKI MFG. CO., LTD.

### Adhesive Force

The adhesive force of an electroconductive pressure-sensitive adhesive tape was determined by the following procedure according to a test method of JIS-Z0237 (2000): 180-Degree Peeling Adhesive Force. Each of the electroconductive pressure-sensitive adhesive tapes obtained in Examples and Comparative Examples was cut into a size of 20 mm width, and one surface of the electroconductive pressure-sensitive adhesive tape was backed with a polyester film having a thickness of 25 μm. Subsequently, under conditions of an environmental temperature of 23° C. and a humidity of 50% RH, the backed electroconductive pressure-sensitive adhesive tape was bonded to a stainless steel (SUS) plate, which was press-bonded by one reciprocation of a 2-kg roller on the top surface thereof, and then, was left at the temperature for 1 hour, thus producing a specimen. With the specimen, the 180-degree peeling adhesive force was measured by peeling the tape at a rate of 300 mm/min under conditions of an environmental temperature of 23° C. and a humidity of 50% RH using a Tensilon universal tensile testing machine (RTA100 manufactured by ORIENTEC CO., LTD.).

### Electrical Conductivity

An electroconductive pressure-sensitive adhesive tape cut into a size of 25 mm width×25 mm width was interposed between two copper foils (thickness 35 μm) and was bonded thereto with a bonding area of 6.25 cm², and was pressed with one reciprocation of a 2.0-kg roller in an environment of 23° C. and 50% RH, thus producing a specimen. After leaving the specimen in the same environment for 1 hour, a terminal was connected to an end of each of the two copper foils, and a current of 10 μA was allowed to flow using a resistivity meter (Loresta-GP MCP-T600, manufactured by Mitsubishi Chemical Corporation) to measure the resistance value. The case of a resistance value of less than 100 mΩ/6.25 cm² was evaluated as “A”.

Swelling Property from Before to After Immersion in Propylene Carbonate (PPC)

The release liners were detached from each of the electroconductive pressure-sensitive adhesive tapes obtained in Examples and Comparative Examples and only the resulting electroconductive pressure-sensitive adhesive layers were stacked and laminated into a length of 10 mm, a width of 10 mm, and a thickness of 1 mm to produce a specimen. Subsequently, the weight (G1) of the specimen before immersion was measured in advance, and the specimen was immersed in propylene carbonate in an environment of 23° C. and 50% RH for 1 week. Then, propylene carbonate remaining on the surface of the specimen was wiped off, and the weight (G2) after drying at 23° C. for 4 hours was measured. According to the following equation, the weight change rate of the electroconductive pressure-sensitive adhesive layer (swelling rate of pressure-sensitive adhesive layer) from before to after leaving the specimen immersed in propylene carbonate in an environment of 23° C. and 50% RH for 1 week was determined to evaluate the swelling property from before to after immersion in propylene carbonate (PPC) according to the following criteria.

$$Weight change rate ( swelling rate ) of pressure - sensitive adhesive layer from before to after immersion in \\ propylene carbonate [ \% by weight ] = \{ ( G 2 / G 1 ) \times 100 \} - 100$$

### Evaluation Criteria

A: Weight change rate of 3% by weight or less
B: Weight change rate of more than 3% by weight and 5% by weight or less
C: Weight change rate of more than 5% by weight and 10% by weight or less
D: Weight change rate of more than 10% by weight
   Swelling Property from Before to After Immersion in Dimethyl Carbonate (DMC)

The release liners were detached from each of the electroconductive pressure-sensitive adhesive tape obtained in Examples and Comparative Examples and the electroconductive pressure-sensitive adhesive tapes after detaching the release liners (only the resulting electroconductive pressure-sensitive adhesive layers) were stacked into a length of 10 mm, a width of 10 mm, and a thickness of 1 mm to produce a specimen. Subsequently, the weight (G3) of the specimen before immersion was measured in advance, and the specimen was immersed in dimethyl carbonate in an environment of 23° C. and 50% RH for 1 week. Then, dimethyl carbonate remaining on the surface of the specimen was wiped off, and the weight (G4) after drying at 23° C. after 4 hours was measured. According to the following equation, the weight change rate of the electroconductive pressure-sensitive adhesive layer (swelling rate of electroconductive pressure-sensitive adhesive layer) from before to after leaving the specimen immersed in dimethyl carbonate in an environment of 23° C. and 50% RH for 1 week was determined to evaluate the swelling property from before to after immersion in dimethyl carbonate (DMC) according to the following criteria.

$$Weight change rate ( swelling rate ) of electroconductive pressure - sensitive adhesive layer from before to after immersion in dimethyl carbonate [ \% by weight ] = \{ ( G 4 / G 3 ) \times 100 \} - 100$$

### Evaluation Criteria

A: Weight change rate of 3% by weight or less
B: Weight change rate of more than 3% by weight and 5% by weight or less
C: Weight change rate of more than 5% by weight and 10% by weight or less
D: Weight change rate of more than 10% by weight

The evaluation results are shown in the following tables.

TABLE 1

| | | | | Example | Example | Example | Example | Example | Example |
|---|---|---|---|---|---|---|---|---|---|
| | | | | 1 | 2 | 3 | 4 | 5 | 6 |
| Electroconductive pressure-sensitive adhesive composition | | | | A | B | C | D | E | F |
| Compositional | Rubber | Polyisobutylene | Mv: | 90 | 70 | 50 | 30 | 10 | 50 |
| formulation | component | (A1) | 425,000 | | | | | | |
| [parts by | | Polyisobutylene | Mv: | 0 | 0 | 0 | 0 | 0 | 0 |
| weight] | | (A2) | 800,000 | | | | | | |
| | | Polyisobutylene | Mv: | 10 | 30 | 50 | 70 | 90 | 0 |
| | | (B1) | 60,000 | | | | | | |
| | | Polyisobutylene | Mv: | 0 | 0 | 0 | 0 | 0 | 50 |
| | | (B2) | 30,000 | | | | | | |

| | | | | | | | |
|---|---|---|---|---|---|---|---|
| Tackifying resin (1) | Softening | 36 | 36 | 36 | 36 | 36 | 36 |
| | point: | | | | | | |
| | 125° C. | | | | | | |
| Tackifying resin (2) | Softening | 0 | 0 | 0 | 0 | 0 | 0 |
| | point: | | | | | | |
| | 85° C. | | | | | | |

| | | | | | | |
|---|---|---|---|---|---|---|
| Nickel powder (1) [parts by weight] | 1 | 1 | 1 | 1 | 1 | 1 |

| Electroconductive pressure-sensitive adhesive layer | | 10 | 10 | 10 | 10 | 10 | 10 |
|---|---|---|---|---|---|---|---|
| thickness [μm] | | | | | | | |
| Evaluation | Swelling property (PPC) | A | A | B | B | B | B |
| | Swelling property (DMC) | A | A | B | B | B | B |
| | Adhesive force [N/20 mm] | 7 | 12 | 12 | 13 | 13 | 12 |
| | Resistance value | A | A | A | A | A | A |

| | | | | Example 7 | Example 8 | Example 9 | Example 10 | Example 11 |
|---|---|---|---|---|---|---|---|---|
| Electroconductive pressure-sensitive adhesive composition | | | | G | H | I | J | K |
| Compositional | Rubber | Polyisobutylene | Mv: | 70 | 50 | 50 | 0 | 50 |
| formulation | component | (A1) | 425,000 | | | | | |
| [parts by | | Polyisobutylene | Mv: | 0 | 0 | 0 | 50 | 0 |
| weight] | | (A2) | 800,000 | | | | | |
| | | Polyisobutylene | Mv: | 0 | 50 | 50 | 50 | 50 |
| | | (B1) | 60,000 | | | | | |
| | | Polyisobutylene | Mv: | 30 | 0 | 0 | 0 | 0 |
| | | (B2) | 30,000 | | | | | |

| | | | | | | |
|---|---|---|---|---|---|---|
| Tackifying resin (1) | Softening | 36 | 0 | 0 | 36 | 0 |
| | point: | | | | | |
| | 125° C. | | | | | |
| Tackifying resin (2) | Softening | 0 | 36 | 71.8 | 0 | 0 |
| | point: | | | | | |
| | 85° C. | | | | | |

| | | | | | |
|---|---|---|---|---|---|
| Nickel powder (1) [parts by weight] | 1 | 1 | 1 | 1 | 1 |

| Electroconductive pressure-sensitive adhesive layer | | 10 | 10 | 10 | 10 | 10 |
|---|---|---|---|---|---|---|
| thickness [μm] | | | | | | |
| Evaluation | Swelling property (PPC) | A | B | B | A | B |
| | Swelling property (DMC) | A | B | B | A | B |
| | Adhesive force [N/20 mm] | 12 | 12 | 12 | 13 | 7 |
| | Resistance value | A | A | A | A | A |

TABLE 2

| | | | | Comparative | Comparative | Comparative | Comparative |
|---|---|---|---|---|---|---|---|
| | | | | Example 1 | Example 2 | Example 3 | Example 4 |
| Electroconductive pressure-sensitive adhesive | | | | L | M | N | O |
| composition | | | | | | | |
| Compositional | Rubber | Polyisobutylene | Mv: | 100 | 100 | 0 | 0 |
| formulation | component | (A1) | 425,000 | | | | |
| [parts by | | Polyisobutylene | Mv: | 0 | 0 | 0 | 0 |
| weight] | | (A2) | 800,000 | | | | |
| | | Polyisobutylene | Mv: | 0 | 0 | 100 | 100 |
| | | (B1) | 60,000 | | | | |
| | | Polyisobutylene | Mv: | 0 | 0 | 0 | 0 |
| | | (B2) | 30,000 | | | | |

| | | | | | |
|---|---|---|---|---|---|
| Tackifying resin (1) | Softening | 36 | 0 | 36 | 0 |
| | point: | | | | |
| | 125° C. | | | | |
| Tackifying resin (2) | Softening | 0 | 0 | 0 | 0 |
| | point: | | | | |
| | 85° C. | | | | |

| | | | | |
|---|---|---|---|---|
| Nickel powder (1) [parts by weight] | 1 | 1 | 1 | 1 |

| Electroconductive pressure-sensitive adhesive layer | | 10 | 10 | 10 | 10 |
|---|---|---|---|---|---|
| thickness [μm] | | | | | |
| Evaluation | Swelling property (PPC) | B | B | C | C |
| | Swelling property (DMC) | B | B | D | D |
| | Adhesive force [N/20 mm] | 3 | 3 | 12 | 9 |
| | Resistance value | A | A | A | A |

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. An electroconductive pressure-sensitive adhesive tape comprising at least an electroconductive pressure-sensitive adhesive layer,
wherein the electroconductive pressure-sensitive adhesive layer comprises: at least,
a rubber component; and
electroconductive particles, and
the rubber component contains:
a polyisobutylene (A) that has a viscosity average molecular weight of 400,000 or more and 800,000 or less, and
a polyisobutylene (B) that has a viscosity average molecular weight of 100,000 or less.

2. The electroconductive pressure-sensitive adhesive tape according to claim 1, wherein the polyisobutylene (A) and the polyisobutylene (B) are contained in a weight ratio [(A)/(B)] in a range of 1/9 to 9/1.

3. The electroconductive pressure-sensitive adhesive tape according to claim 1, wherein the electroconductive pressure-sensitive adhesive layer further comprises a tackifying resin.

4. The electroconductive pressure-sensitive adhesive tape according to claim 3, wherein the tackifying resin is one or more selected from an aliphatic hydrocarbon resin, an alicyclic hydrocarbon resin, an aliphatic-alicyclic hydrocarbon resin, and a hydrogenated resin thereof.

5. The electroconductive pressure-sensitive adhesive tape according to claim 3, wherein the tackifying resin is contained in an amount of 80 parts by weight or less relative to 100 parts by weight of the rubber component.

6. The electroconductive pressure-sensitive adhesive tape according to claim 4, wherein the tackifying resin is contained in an amount of 80 parts by weight or less relative to 100 parts by weight of the rubber component.

7. The electroconductive pressure-sensitive adhesive tape according to claim 1, wherein both surfaces of the electroconductive pressure-sensitive adhesive layer each form a pressure-sensitive adhesive surface of the electroconductive pressure-sensitive adhesive tape.

8. The electroconductive pressure-sensitive adhesive tape according to claim 1, wherein a weight change rate (swelling rate) of the electroconductive pressure-sensitive adhesive layer before immersing the electroconductive pressure-sensitive adhesive tape in dimethyl carbonate in an environment of 23° C. and 50% RH for 1 week to after leaving the electroconductive pressure-sensitive adhesive tape immersed in the dimethyl carbonate in the environment of 23° C. and 50% RH for 1 week is 10% by weight or less.

9. A cell or battery comprising the electroconductive pressure-sensitive adhesive tape according to claim 1.
